(19) United States
(12) Patent Application Publication
(10) Pub. No.: US 2021/0084920 A1
(43) Pub. Date: Mar. 25, 2021

(54) METHOD FOR FREEZING VEGETABLES OR FRUIT

(71) Applicant: TableMark Co., Ltd., Tokyo (JP)

(72) Inventor: Erika TERAKUBO, Tokyo (JP)

(73) Assignee: TableMark Co., Ltd., Tokyo (JP)

(21) Appl. No.: 17/112,770

(22) Filed: Dec. 4, 2020

Related U.S. Application Data
(63) Continuation of application No. PCT/JP2019/022302, filed on Jun. 5, 2019.

(30) Foreign Application Priority Data
Jun. 5, 2018 (JP) 2018-107926

(51) Int. Cl. A23B 7/04; A23B 7/06; A23L 3/36; A23L 19/00

(52) U.S. Cl. CPC A23B 7/0441; A23B 7/06; A23V 2002/00; A23L 19/03; A23L 3/36

(57) ABSTRACT

The present invention relates to a method for freezing vegetables or fruit. The method of the present invention is a method for freezing vegetables or fruit, including (i) subjecting vegetables or fruit to heat treatment; (ii) cooling the vegetables or fruit of step (i), thereby allowing the vegetables or fruit to become in a supercooled state, and subsequently releasing the supercooled state; and (iii) freezing the vegetables or fruit of step (ii). Here, the heat treatment of (i) is heat treatment to the extent at which cell tissues of the vegetables or fruit are not destroyed even after freezing treatment of (iii).

### CROSS REFERENCE TO RELATED APPLICATIONS

The present application is a continuation application of International Application No. PCT/JP2019/022302, filed on Jun. 5, 2019.

### TECHNICAL FIELD

The present invention relates to a method for freezing vegetables or fruit and to frozen vegetables or fruit.

### BACKGROUND ART

Freezing Treatment of Vegetables

Food freezing technique realizes long-term preservation of food and subsequent simplified cooking and greatly contributes to improvement of diet. However, this food freezing technique is still incomplete technique and leaves room for consideration. Food freezing technique of fresh green-groceries such as vegetables and fruit is one of such technique.

Conventionally, a combination of pretreatment such as blanching (heat treatment) and a quick freezing method has been used in freezing vegetables in order to suppress enzymatic changes during preservation. Blanching is heat treatment such as boiling or steaming conducted during preparation of frozen vegetables. Changes in nutrient components and hue are suppressed by deactivating enzymes in vegetables through such preliminary heat treatment. Treatment conditions of blanching are often based on the deactivation of peroxidase and catalase, which are heat-resistant enzymes, as an indication for the purpose thereof. On the other hand, vegetables are softened and get soft when heat treatment is applied thereto.

In addition, quick freezing technique is a technique for suppressing texture deterioration of food by allowing food to pass through the maximum ice crystal production zone (−1 to −5° C.) in which ice crystal growth rate in food is slow in a short time. Quick freezing is widely used for common food and is commercially widely used for vegetables having been subjected to blanching treatment since destruction of tissues can be reduced by quick freezing. Among vegetable material, however, fresh vegetables cannot maintain their textures even with quick freezing.

Accordingly, it has been thought that even the combination of blanching treatment and quick freezing technique is not applicable for vegetables putting importance on crispy texture as in salad vegetables, which is innate in fresh vegetables and has high palatability, or on moderate texture obtained after lightly stir-frying vegetables. (“Yasai jouhou (Vegetable Information),” July 2014, vol. 124, pp. 6-14, “Tokushuu/Kokusanyasai no reitoukakou ni muketa torikumi: Shokuhin no reitougijyutsu to reitouyasai no hinshitsu: Toru Suzuki (Special topic/Approaches for freezing processing of domestic vegetables: freezing technique of food and quality of frozen vegetables: Toru Suzuki)” (reference information: http://vegetable.alic.go.jp/yasaijoho/senmon/1407/chosa01.html))

Japanese Patent Laid-Open No. 2006-271352 describes a manufacturing method of frozen food. In the method described in the literature, superheated steam treatment is conducted on cut vegetables, moisture is reduced simultaneously with heat treatment, and freezing treatment is subsequently conducted. The method is characterized by suppressing dripping (separation of water) which is caused by heat treatment at the time of thawing.

Japanese Patent Laid-Open No. 2005-143366 describes a manufacturing method of frozen carrots. The method described in the literature is characterized in that carrots are heated to the extent that heat does not transfer to the inside of the carrots and then peeled, and freezing is conducted. The purpose of the heat treatment in the method of the literature is to reduce the number of microorganisms attaching to skin surfaces of carrots and to inactivate browning enzymes (Patent Literature 2, paragraph 0021). The freezing condition is quick freezing at −35° C. (Patent Literature 2, paragraphs 0041 and 0047). Paragraph 0005 of the literature raises such a problem in heat treatment such as blanching treatment; that is, “It has been known that many frozen vegetables further deteriorate in texture after freezing and thawing due to heat treatment such as blanching treatment. This is thought to be because damage to cell walls increases by amount corresponding to heating, freezing, and thawing, and tissues become spongy during cryopreservation, with the cell walls losing flexibility.”

As described above, occurrence of dripping, reduction in the number of microorganisms, browning, and the like are prevented at a certain level by conducting blanching treatment, especially superheated steam treatment, and quick freezing in freezing vegetables; however, deterioration in texture due to destruction of tissues has not been able to be suppressed.

Supercooling

Supercooling refers to a state in which, in phase transition of a substance, the phase thereof remains unchanged even at or below the temperature at which the phase should transfer. For example, it is a phenomenon in which a liquid does not freeze even when the liquid is cooled below its freezing point (transition point) and maintains a liquid phase. In the case of water, it refers to a state in which water does not freeze even at 0° C. or lower.

In regard to food, a method in which such a supercooled state is allowed to be generated, the supercooled state is subsequently released at a temperature lower than an original freezing temperature, and fine ice crystals are uniformly produced by freezing at once (supercooling freezing) to suppress destruction of food tissues during freezing due to ice crystals has been suggested recently. However, in supercooling technique for food, a cooling speed for generating supercooled state is low, and quality of food may deteriorate by oxidation, bacterial growth, or the like. In addition, there are following problems and the like: since supercooled states are unstable, supercooling is readily released before the lowest arrival temperature under a supercooled state deeply attains; and when the lowest arrival temperature is shallow, the number of ice nuclei generated at the time of release is small, and consequently, high quality freezing is not possible.

In food freezing, forms of ice crystals greatly affect final quality of food. An article by Kobayashi et al. (Transactions of the Japan Society of Refrigerating and Air Conditioning Engineers, Vol. 31, No. 3 (2014), p. 297-303) describes in detail an effect of supercooling phenomenon on the forms of ice crystals and on dripping during freezing of food using tofu. The article summarizes as follows: “in addition to more detailed studies on conditions such as a supercooling release temperature and a cooling speed after release, establishment of a highly reproductive technique for maintaining a supercooled state, that is, studies on a control method of supercooling are also required for practical use of supercooling freezing methods.” It has been difficult to produce a stable supercooled frozen state for food, especially for succulent vegetables and fruit.

Japanese Patent Laid-Open No. 2016-39787 describes a freezing method of food. The method described in the literature is characterized in that, before supercooling the food, a hydrophobic substance is applied to the surface of the food or a pretreatment process of dissolving a hydrophobic substance on the surface layer is carried out. Edible oil and carbon dioxide are exemplified as the hydrophobic substance.

In addition, Japanese Patent Laid-Open No. 2014-221020 describes a preservation method of fresh green-groceries. The method described in the literature is characterized by preserving fresh green-groceries after being heat-treated in water or in water vapor at least either in a cooled state or in a supercooled state. The purpose of heating is to suppress enzyme activity, and the groceries are held at a temperature of 30 to 50° C. for 10 to 60 minutes. By the method, the green-groceries are preserved under refrigeration and maintained in their supercooled states, but subsequent release of supercooling and subsequent freezing are not suggested at all.

### CITATION LIST

### Patent Literature

PTL 1: Japanese Patent Laid-Open No. 2006-271352
PTL 2: Japanese Patent Laid-Open No. 2005-143366
PTL 3: Japanese Patent Laid-Open No. 2016-39787
PTL 4: Japanese Patent Laid-Open No. 2014-221020

### Non Patent Literature

NPL 1: Transactions of the Japan Society of Refrigerating and Air Conditioning Engineers, Vol. 31, No. 3 (2014), p. 297-303
NPL 2: “Yasai jouhou (Vegetable Information),” July 2014, vol. 124, pp. 6-14, “Tokushuu/Kokusanyasai no reitoukakou ni muketa torikumi: Shokuhin no reitougijyutsu to reitouyasai no hinshitsu: Toru Suzuki (Special topic/Approaches for freezing processing of domestic vegetables: freezing technique of food and quality of frozen vegetables: Toru Suzuki)” (reference information: http://vegetable.alic.go.jp/yasaijoho/senmon/1407/chosa01.html)

### SUMMARY OF INVENTION

### Technical Problem

Vegetables subjected to blanching treatment in advance and subsequently quickly frozen are distributed on the market as frozen vegetables. However, when vegetables having a high moisture level are frozen, since there is a difference in temperature between surfaces of the vegetables and the inside of the vegetables, ice crystals grow toward the surfaces of the vegetables, and tissues break during this process. When tissues are destroyed in this manner, thawed vegetables also lose their peculiar texture, and dripping occurs. Therefore, it has been a problem to freeze vegetables without losing their texture.

Although supercooling freezing has been proposed as a freezing method in which texture deterioration during thawing of food is suppressed, there are such problems that supercooling is difficult to control, and equipment costs are high. Furthermore, this method has not been able to generate a supercooled state even if this method is directly applied to vegetables having a high moisture level.

The present invention aims at solving the above problems and providing frozen vegetables or frozen fruit capable of retaining innate crunchy texture of vegetables and fruit even after freezing followed by thawing, and a method for freezing vegetables or fruit.

### Solution to Problem

The present inventors have revealed that a supercooled state is allowed to be generated by moderately heating vegetables and subjecting the vegetables after being heated to cooling treatment. Furthermore, the present inventors have found that supercooling is further automatically released to allow vegetables to be frozen and that the vegetables having been frozen through heat treatment and a subsequent supercooled state are likely to retain the texture before freezing even after being thawed, and arrived at the present invention. The present invention includes the following aspects but is not limited thereto.

### [Aspect 1]

A method for freezing vegetables or fruit, comprising

(i) subjecting vegetables or fruit to heat treatment;

(ii) cooling the vegetables or fruit of step (i), thereby allowing the vegetables or fruit to become in a supercooled state, and subsequently releasing the supercooled state; and

(iii) freezing the vegetables or fruit of step (ii),

wherein

the heat treatment of step (i) is heat treatment to the extent at which cell tissues of the vegetables or fruit are not destroyed even after freezing treatment of step (iii).

### [Aspect 2]

The freezing method according to aspect 1, wherein the supercooled state is released at −9° C. or lower in step (ii).

### [Aspect 3]

The freezing method according to aspect 1 or 2, wherein the vegetables or fruit is cooled by putting the vegetables or fruit under a condition of −9° C. to −25° C. in step (ii).

### [Aspect 4]

The freezing method according to any one of aspects 1 to 3, wherein the vegetables or fruit is cooled by putting the vegetables or fruit under a condition of −9° C. to −15° C. in step (ii).

### [Aspect 5]

The freezing method according to any one of aspects 1 to 4, wherein moisture on surfaces of the vegetables or fruit is removed after the heat treatment of step (i).

### [Aspect 6]

The method according to any one of aspects 1 to 5, wherein

the heat treatment of step (i) is conducted under a condition of 60° C. to 250° C.

### [Aspect 7]

The method according to any one of aspects 1 to 6, wherein

the heat treatment of step (i) is conducted under a condition of 100° C. to 250° C.

### [Aspect 8]

The method according to any one of aspects 1 to 7, wherein

the heat treatment of step (i) is conducted for 10 seconds to 600 seconds.

### [Aspect 9]

The method according to any one of aspects 1 to 8, wherein

the heat treatment of step (i) is conducted for 30 seconds to 600 seconds.

### [Aspect 10]

The method according to any one of aspects 1 to 9, wherein

the heat treatment of step (i) is conducted by superheated steam heating, steaming heating, or stir-frying heating.

### [Aspect 11]

The method according to any one of aspects 1 to 10, wherein the release of the supercooled state of step (ii) naturally occurs without any external stimulus.

### [Aspect 12]

The method according to any one of aspects 1 to 11, wherein the vegetables are selected from the group consisting of bean sprouts, onions, bell peppers, paprikas, carrots, radishes, spinach, cabbages, lettuces, broccolis, cauliflowers, asparagus, potatoes, green onions, and ginger.

### [Aspect 13]

The method according to any one of aspects 1 to 11, wherein the fruit is selected from the group consisting of apples, watermelons, pears, grapes, peaches, mangoes, citrus fruits, bananas, pineapples, and berries.

### [Aspect 14]

Vegetables or fruit frozen by the method according to any one of aspects 1 to 13.

### [Aspect 15]

A method for freezing vegetables or fruit, comprising

(i) subjecting vegetables or fruit to heat treatment;

(ii) cooling the vegetables or fruit of step (i) by allowing the vegetables or fruit stand still under a condition of −1° C. to −18° C., thereby allowing the vegetables or fruit to become in a supercooled state, and subsequently releasing the supercooled state; and

(iii) freezing the vegetables or fruit of step (ii),

wherein

the heat treatment of step (i) is heat treatment to the extent at which cell tissues of the vegetables or fruit are not destroyed even after freezing treatment of step (iii).

### [Aspect 16]

The freezing method according to aspect 15, wherein

the vegetables or fruit is cooled by allowing the vegetables or fruit stand still under a condition of −9° C. to −18° C. in step (ii).

### [Aspect 17]

The freezing method according to aspect 15, wherein

the vegetables or fruit is cooled by allowing the vegetables or fruit stand still under a condition of −9° C. to −15° C. in step (ii).

### Advantageous Effects of Invention

The freezing method of the present invention enables to manufacture frozen vegetables which retain texture of vegetables even after freezing followed by thawing. The frozen vegetables of the present invention have superior texture compared with vegetables or fruit frozen without undergoing a supercooled state (example: quick freezing), and are available for various frozen food which have been thought to be impossible to be applied.

### BRIEF DESCRIPTION OF DRAWINGS

FIG. 1 shows a schematic diagram of texture analyzer attachments of Stable Micro Systems.

FIG. 2 is texture measurement results. CI (Crispiness Index (%)) of the longitudinal axis demonstrates a proportion of bean sprouts having texture similar to that of uncooked bean sprouts (fresh) based on all the bean sprouts subjected to texture measurement.

FIG. 3A shows X-ray CT images of frozen bean sprouts. FIG. 3A shows supercooled frozen bean sprouts.

FIG. 3B shows X-ray CT images of frozen bean sprouts. FIG. 3B shows quickly frozen bean sprouts.

FIG. 4 illustrates a process of measuring a deflection angle of steamed bean sprouts using a support and a protractor.

FIG. 5 illustrates a premise for calculating Young's moduli in Examples.

FIG. 6 shows results of examination on elastic moduli (Young's moduli) when freezing temperature of bean sprouts is varied.

### DESCRIPTION OF EMBODIMENTS

1. Method for Freezing Vegetables or Fruit

In one aspect, the present invention relates to a method for freezing vegetables or fruit.

The freezing method of the present invention includes but not limited to the following:

(i) subjecting vegetables or fruit to heat treatment:

(ii) cooling the vegetables or fruit of step (i), thereby allowing the vegetables or fruit to become in a supercooled state, and subsequently releasing the supercooled state: and

(iii) freezing the vegetables or fruit of step (ii).

Here, the heat treatment of step (i) is heat treatment to the extent at which cell tissues of the vegetables or fruit are not destroyed even after freezing treatment of step (iii).

In the method of the present invention, fresh food such as vegetables, fruit, or the like is frozen by cooling the fresh food after heat treatment. One feature is that a supercooled state is generated and the supercooled state is subsequently released before reaching a frozen state. By virtue of this feature, texture deterioration of fresh food before and after freezing can be more suppressed compared with the case where fresh food is directly frozen without undergoing supercooling, and thus frozen food retaining texture of fresh food can be obtained.

Heat Treatment

The heat treatment of step (i) is not harsh so as to avoid destroying cell tissues of the vegetables or fruit even after the freezing treatment of step (iii). When high heat treatment is applied to the extent that cell tissues of the vegetables or fruit are destroyed and not retained, texture such as chewiness, crispness, and crunchy feeling deteriorates to ruin taste, which is not preferable.

On the other hand, when the step of heat treatment of (i) is improperly conducted, the supercooled state and subsequent release of the supercooled state are not provided in the cooling step of (ii). In one aspect, it is a state where a suitable damage is given to cells of the vegetables or fruit, and while a supercooled state is generated within the cells, not all of the cells are destroyed. Alternatively, it is a state where cells are damaged, and while a supercooled state is generated also within the cells, destruction of cell tissues does not occur.

In the method of the present invention, treatment other than the heat treatment of step (i), such as treatment of adding an additive for providing a supercooled state and subsequent release of the supercooled state is not required in the cooling step of (ii). In one aspect of the method of the present invention, treatment other than the heat treatment of step (i) such as treatment of adding an additive is not conducted in the cooling step of (ii) for providing a supercooled state and subsequent release of the supercooled state.

A method for conducting heat treatment is not particularly limited, and heat treatment can be conducted by any known method. In one aspect, heat treatment is conducted by superheated steam heating, steaming heating, or stir-frying heating. Superheated steam heating and steaming heating are preferable. Boiling heating (blanching) may be also employed. However, boiling heating (blanching) requires more careful setting for heating conditions because the moisture is more likely to penetrate into the inside of vegetables or fruit during heating, and the moisture level tends to increase compared with superheated steam heating, steaming heating, and stir-frying heating. Superheated steam heating is most preferable.

The temperature and time for applying the step of heat treatment vary, depending on factors such as the type, moisture level, size, shape, and composition of vegetables or fruit to be frozen, a state at the time of freezing, and conditions at the time of supercooling and subsequent release of supercooling, as well as a frozen state, a state of preservation, and the like.

In one aspect, the heat treatment of step (i) is preferably conducted at 60° C. or higher, 70° C. or higher, 80° C. or higher, 90° C. or higher, 100° C. or higher, or 120° C. or higher. More preferably, the heat treatment of step (i) is conducted at 100° C. or higher. In one aspect, the heat treatment of step (i) is preferably conducted at 300° C. or lower, 280° C. or lower, 250° C. or lower, 200° C. or lower, or 80° C. or lower. In one aspect, the heat treatment of step (i) is conducted under a condition of 60° C. to 250° C. In one aspect, the heat treatment of step (i) is conducted under a condition of 100° C. to 250° C.

In one aspect, the heat treatment of step (i) is conducted for 10 seconds or longer, 20 seconds or longer, 30 seconds or longer, 45 seconds or longer, 60 seconds or longer, 90 seconds or longer, 100 seconds or longer, 120 seconds or longer, 180 seconds or longer, or 300 seconds or longer. In one aspect, the heat treatment of step (i) is conducted for 900 seconds or shorter, 600 seconds or shorter, 300 seconds or shorter, 200 seconds or shorter, or 180 seconds or shorter. In one aspect, the heat treatment of step (i)) is conducted for 10 seconds to 600 seconds. In one aspect, the heat treatment of step (i) is conducted for 30 seconds to 600 seconds.

In one aspect, the heat treatment of step (i) is conducted under a condition of 60° C. to 250° C. for 10 seconds to 600 seconds. In one aspect, the heat treatment of step (i) is conducted under a condition of 100° C. to 250° C. for 10 seconds to 600 seconds. In one aspect, the heat treatment of step (i) is conducted under a condition of 60° C. to 250° C. for 30 seconds to 600 seconds. In one aspect, the heat treatment of step (i) is conducted under a condition of 100° C. to 250° C. for 30 seconds to 600 seconds.

In the Examples of the present specification, heat treatment was conducted on various vegetables and fruit under various conditions to obtain frozen vegetables and fruit. In one aspect, the heating conditions under which supercooling and release of supercooling were provided and frozen vegetables or fruit was obtained in these examples may be applied. In one aspect, heating conditions under which sensory evaluation scores 9 points or more, 10 points or more, 11 points or more, or 12 points or more in the Examples (especially, Example 1 and Example 8) beyond 9 points, which is the rating obtained at the time of quick freezing, are preferable. In one aspect, heating conditions under which the sense ≥12 rate (rate wherein the result of sense evaluation is 12 points or more) is 20% or more, 25% or more, 30% or more, 35% or more, 40% or more, or 50% or more in the examples (especially. Example 1 and Example 8) are preferable. In one aspect, heating conditions under which a supercooling release temperature is −7° C. or lower, −8° C. or lower, −9° C. or lower, or −10° C. or lower in the Examples (especially, Example 1 and Example 8) are preferable.

Heating conditions can be different from those used in the Examples depending on factors such as the type, moisture level, size, shape, and composition of vegetables or fruit to be frozen, and state at the time of freezing, and conditions at the time of supercooling and subsequent release of supercooling, as well as a frozen state, a state of preservation, and the like. For example, in a case of vegetables or fruit having a larger size, a harsher heating condition (for example, heat treatment for longer time, or the like) may be required, and in a case of having a smaller size, the heating conditions may be oppositely adjusted. In addition, when vegetables or fruit is cut, conditions vary according to the size and shape after cutting. A milder heating condition (for example, heat treatment for a shorter time, or the like) may be required for vegetables or fruit having been cut into a smaller size, and the heating conditions may be oppositely adjusted in a case of a larger cut size. Alternatively, a milder heating condition (for example, heat treatment for a shorter time, or the like) may be required in a case where the moisture level is high or in a case where vegetables or fruit gets soft due to ripening, for example. In addition, conditions such as time may also vary according to a device used for heat treatment and the like. In addition, in a case of stir-frying heating, the time for heat treatment also varies according to heating power. Those skilled in the art can appropriately apply suitable heating conditions according to the situation of vegetables or fruit to be frozen, a device used, and the like.

It is preferable that moisture does not attach to surfaces of the vegetables or fruit to be subjected to the cooling step of (ii) because an effect of lowering supercooling release temperature and/or an effect of obtaining highly sensory-evaluated frozen vegetables or fruit are readily obtained. Therefore, in one aspect, moisture on the surfaces of the vegetables or fruit is removed after the heat treatment of step (i). Especially, in the steaming heating, since processing is conducted in a state of being filled with saturated water vapor, excess moisture is present on tissue surfaces after heat treatment. In such a case, moisture present on the surfaces of the vegetables or fruit is preferably removed. A method for removing moisture is not particularly limited. Moisture can be removed by pressing hygroscopic cloth or paper such as a paper towel against the surfaces, or other ways.

It is preferable that heat treatment is evenly conducted through the inside of vegetables or fruit (evenness of heating), but there is no limitation.

Cooling Treatment

The vegetables or fruit of step (i) is subsequently cooled. Consequently, the vegetables or fruit comes into a supercooled state, and the supercooled state is subsequently released.

A temperature at which the supercooled state is released is not particularly limited. In one aspect, the supercooling release temperature is −1° C. or lower, −3° C. or lower, −5° C. or lower, −7° C. or lower, −9° C. or lower, or −10° C. or lower. The supercooling release temperature is preferably −9° C. or lower or −10° C. or lower. In one aspect, in step (ii), the supercooling release temperature at which the supercooled state is released at −9° C. or lower can be indicated by an arithmetic average of supercooling release temperatures of vegetables or fruit in which their supercooled states are released, for example.

Conditions such as a temperature, time, method, and the like for cooling are not particularly limited. Vegetables or fruit can be cooled by allowing the vegetables or fruit to stand still under a temperature of 0° C. or lower. Since the vegetables or fruit is required to stand under a temperature lower than the supercooling release temperature, in one aspect, a cooling temperature is −1° C. or lower, −3° C. or lower, −5° C. or lower, −7° C. or lower, −9° C. or lower, or −10° C. or lower. In one aspect, the cooling temperature is −30° C. or higher, −25° C. or higher, −20° C. or higher, −18° C. or higher, −15° C. or higher, or −12° C. or higher.

In one aspect, in step (ii), the vegetables or fruit is cooled by putting the vegetables or fruit under a condition of −9° C. to −25° C. In one aspect, in step (ii), the vegetables or fruit is cooled by putting the vegetables or fruit under a condition of −9° C. to −15° C.

A cooling time is not particularly limited. A time required for supercooling, release of a supercooled state, and freezing to occur is enough. In one aspect, the cooling time is 5 minutes or longer, 10 minutes or longer, 15 minutes or longer, 20 minutes or longer, or 30 minutes or longer. By putting the vegetables or fruit under a temperature lower than the above-described supercooling release temperature, the method may proceed to the freezing step of (iii). Alternatively, vegetables or fruit having been released from the supercooled state and frozen may be transferred to a freezing condition with a lower temperature. The cooling step of (ii) can be conducted by a device such as a freezer, a deep freezer, a low temperature thermostatic device, for example. A device capable of controlling temperature is preferable, but there is no limitation.

Generally, when any kind of stimulation such as vibration is applied to a liquid in a supercooled state, the liquid rapidly crystallizes, and the supercooled state is released. However, in one aspect of the present invention, release of the supercooled state in step (ii) naturally occurs over time during the cooling step without any external stimulus.

Vegetables or Fruit

Types of vegetables or fruit to be frozen by the above-described method are not particularly limited. In one aspect, vegetables or fruit having a higher moisture level is preferable. In one aspect, vegetables or fruit having a smaller size and shape is preferable.

In one aspect, the vegetables are selected from the group consisting of bean sprouts, onions, bell peppers, paprikas, carrots, radishes, spinach, cabbages, lettuces, broccolis, cauliflowers, asparagus, potatoes, green onions, and ginger, but are not limited thereto.

In one aspect, the fruit is selected from the group consisting of apples, watermelons, pears, grapes, peaches, mangoes, citrus fruits such as tangerines, bananas, pineapples, and berries such as strawberries and blueberries but is not limited thereto. Citrus fruits include tangerines, oranges, Citrus hassaku, Citrus nalsudaidai, and Dekopon. Berries include strawberries, blueberries, and raspberries. More preferably, the fruit is selected from the group consisting of apples, watermelons, pears, grapes, peaches, mangoes, tangerines, bananas, pineapples, strawberries, and blueberries.

The above-described method is applicable for fresh food containing water besides vegetables or fruit.

2. Frozen Vegetables or Fruit

In one aspect, the present invention relates to frozen vegetables or fruit frozen by the above-described method.

The types of the vegetables or fruit are the same as those described in “1. Method for freezing vegetables or fruit.” The vegetables or fruit includes those thawed after freezing besides those in frozen states.

The vegetables or fruit has such a feature that cell tissues of the vegetables or fruit are not destroyed even after freezing treatment. In one aspect, the vegetables or fruit moderately receives damage and is in a state where supercooling may occur, but there is no limitation.

In one aspect, the vegetables or fruit has excellent texture compared with vegetables or fruit frozen without undergoing a supercooled state (example: quick freezing). Excellent texture means that one or more or all of chewiness, crispness, and crunchy feeling are superior (highly evaluated) for example. In one aspect, in the vegetables or fruit, tissues are not destroyed, occurrence of dripping lessens, dilution is consequently not caused, and strong umami taste is felt. In addition, texture is also maintained as the tissues survive.

In one aspect, the vegetables or fruit may have superior texture described above not only by natural thawing but also by thawing with microwaving, thawing with a pot, and the like. The vegetables may be used for vegetable ingredient-containing ramen and vegetable ingredient-containing fried rice, for example. In addition, stir-fried vegetables having texture similar to fresh vegetables can be manufactured also by directly conducting stir-frying treatment to perform cooking such as stir-frying of vegetables.

### EXAMPLES

Hereinafter, the present invention will be described in detail based on Examples, but the present invention is not limited to these Examples. Those skilled in the art can easily make modification and change to the present invention based on the description of the present specification, and they are included in the technical range of the present invention.

### Example 1

Examination of heating conditions in case of using superheated steam In the present Example, heating conditions in a case of using superheated steam as heat treatment were evaluated on bean sprouts.

(1) Heat Treatment and Cooling and Freezing Treatment

In heat treatment, pretreatment was conducted on 50 g of fresh bean sprouts (mung bean sprouts manufactured by Narita Foods Co., Ltd.) with superheated steam of 100° C., 120° C., 180° C., 220° C., or 250° C. for 60 seconds or 100 seconds using a superheated steam oven (manufactured by NAOMOTO CORPORATION). Blanching treatment was conducted by immersing the bean sprouts in boiled water for 60 seconds or 100 seconds.

Thereafter, a thermocouple (manufactured by Ninomiya Electric Wire Co., Ltd.) was vertically inserted into each bean sprout selected from 50 g of bean sprouts having been subjected to heat treatment. Each of the bean sprouts into which the thermocouple was inserted was further allowed to stand still in a program low temperature incubator (manufactured by Yamato Scientific Co., Ltd.) set at −15° C. in advance for 15 minutes to observe appearance of each bean sprout and record a temperature change. The experiment in the same manner was repeated at least two times to determine accuracy.

Fresh bean sprouts (mung bean sprouts manufactured by Narita Foods Co., Ltd.) without pretreatment were allowed to stand still in a freezer with an atmospheric temperature of −15° C. in advance and used as a Comparative Example.

(2) Measurement of Each Property

The obtained each bean sprout was observed, and the number of bean sprouts in which supercooling occurred, the number of bean sprouts in which supercooling was released after being supercooled, and the temperature at which supercooling of these bean sprouts was released were measured from their appearances and the recorded temperature change. From these results, influence on a supercooling rate of bean sprouts (number of bean sprouts in which supercooling occurred/total number of bean sprouts) in each pretreatment temperature, an occurrence rate of release of supercooling (number of bean sprouts in which supercooling was released/number of bean sprouts in which supercooling occurred), and supercooling temperature (arithmetic average of supercooling release temperatures of bean sprouts in which supercooling was released) were calculated. In addition, each sample was subjected to sensory examination, and its texture was tested.

A moisture level of bean sprouts was measured by a common method using an infrared moisture analyzer (manufactured by Kett Electric Laboratory).

(3) Sensory Examination

Sensory examination was conducted on five bean sprouts (mung bean sprouts manufactured by Narita Foods Co., Ltd.) after freezing, which were each put into a bag and allowed to stand still at room temperature for one hour, and according to the criteria shown below, chewiness (stress, force felt at the time of chewing), crispness (force required at the time of breaking), and crunchy feeling (a sense of feeling preferable crunchiness as texture felt at the time of chewing green-groceries) were respectively scored according to the following criteria on a five-point scale and evaluated. Meanwhile, these scores of 15 points in total were added together, and a proportion of bean sprouts scoring 12 points or more (sense ≥12 rate), which were regarded as good, among the five bean sprouts was shown, with one having the total value thereof of 12 points or more regarded as good. Accuracy was improved by conducting the above-described test two cycles, and the sensory evaluation was conducted by five evaluators trained to have common evaluation criteria in advance.

1: Chewiness and crispness are poor, and no crunchy feeling is provided

2: Chewiness and crispness are not good, and less crunchy feeling is provided

3: Chewiness, crispness, and crunchy feeling are provided at certain degrees (texture equivalent to that obtained in the case of quickly freezing after blanching)

4: Chewiness, crispness, and crunchy feeling are provided

5: Chewiness, crispness, and crunchy feeling are very preferable (texture equivalent to that obtained directly after blanching)

(4) Results

Results of the moisture levels, supercooling rates, release occurrence rates, supercooling release temperatures (° C.), rates of supercooling release temperature ≤−9° C., sensory evaluation, and sense ≥12 rates are shown in Tables 1 to 7.

TABLE 1

| Moisture level | Fresh | 100° C. | 120° C. | 180° C. | 220° C. | 250° C. | Blanching |
|---|---|---|---|---|---|---|---|
| 60 seconds | 88.4% | 91.2% | 90.1% | 89.7% | 89.3% | 86.8% | 96.3% |
| 100 seconds | | 90.8% | 89.8% | 88.1% | 86.6% | 85.4% | 96% |

The moisture levels were measured by a common method using an infrared moisture analyzer (manufactured by Kett Electric Laboratory).

TABLE 2

| Supercooling | | 100° | 120° | 180° | 220° | 250° | |
|---|---|---|---|---|---|---|---|
| rate | Fresh | C. | C. | C. | C. | C. | Blanching |
| 60 seconds | 0% | 50% | 75% | 100% | 100% | 100% | 37% |
| 100 seconds | | 100% | 100% | 100% | 100% | 100% | 100% |

A supercooling rate is a proportion of the number of bean sprouts in which supercooling occurred among randomly selected 10 bean sprouts.

The supercooling rates have revealed that as the heating temperature of pretreatment increases, a supercooled state constantly occurs from a short time of 100 seconds and over at a heating temperature of 120° C. and about 60 seconds at 180° C. or higher. While no supercooled state occurs in fresh bean sprouts, occurrence of a supercooled state is stimulated by conducting heating as pretreatment, and occurrence of a supercooled state is stabilized by further strengthening the heating condition.

Next, an occurrence rate of so-called “release of a supercooled state” in which a supercooled state is released and ice crystals are generated was tested.

TABLE 3

| Supercooling | | 100° | 120° | 180° | 220° | 250° | |
|---|---|---|---|---|---|---|---|
| release rate | Fresh | C. | C. | C. | C. | C. | Blanching |
| 60 seconds | 0% | 100% | 100% | 50% | 100% | 100% | 100% |
| 100 seconds | | 100% | 100% | 100% | 43% | 17% | 100% |

A release occurrence rate is a proportion of bean sprouts frozen due to generation of ice crystals after supercooling of the bean sprouts having been supercooled is released. It has been suggested that release of supercooling completely occurs from 60 seconds at a pretreatment temperature of 100° C. and 100% occurs up to 220° C., however release of supercooling does not occur as the time becomes longer when the pretreatment temperature exceeds 250° C., and while a supercooled state is generated by conducting heating, release of supercooling is influenced thereby.

TABLE 4

| Supercooling | | | | | | | |
|---|---|---|---|---|---|---|---|
| release | | | | | | | |
| temperature | | 100° | 120° | 180° | 220° | 250° | |
| (° C.) | Fresh | C. | C. | C. | C. | C. | Blanching |
| 60 seconds | — | −4.7 | −9.8 | −11.2 | −11.8 | −12.1 | −6.2 |
| 100 seconds | | −10 | −10.8 | −11.6 | −11.9 | −10.7 | −7.6 |

A supercooling release temperature is a minimum temperature at which bean sprouts having entered a supercooled state arrive while retaining the supercooled state and without releasing supercooling. While the supercooling release temperature varied, the supercooling temperature decreased as the heating temperature and heating time increased, almost all samples reached −9° C. or lower when the heating temperature exceeded 180° C., and the average of the supercooling release temperatures also exhibited about −11° C. When the pretreatment conditions became more severe, although supercooling occurs, occurrence of release was not observed in many samples, and an apparent supercooling temperature consequently increased.

TABLE 5

| Rate of | | | | | | | |
|---|---|---|---|---|---|---|---|
| supercooling | | | | | | | |
| temperature ≤ | | 100° | 120° | 180° | 220° | 250° | |
| −9° C. | Fresh | C. | C. | C. | C. | C. | Blancing |
| 60 seconds | 0% | 33% | 25% | 100% | 100% | 86% | 0% |
| 100 seconds | | 50% | 29% | 100% | 100% | 100% | 0% |

The “rate of supercooling release temperature ≤−9° C.” in Table 5 is a proportion of the number of supercooled bean sprouts reaching −9° C. or lower. The rate of the supercooling release temperature ≤−9° C. increases as the heating temperature of pretreatment increases. A supercooled state occurred at a rate of 100% at a heating temperature of 180° C. to 220° C. in any time condition of 60 seconds and 120 seconds.

In sensory examination, panelists made evaluation with respect to three items (chewiness, crispness, and crunchy feeling), which are especially evaluated as toughness, on a 15-point scale. Results are shown in Table 6. Evaluation was made in a method in which those having a total value of sensory evaluation of more than 12 points are regarded as having good texture (toughness). The “sense ≥12 rate” in Table 7 is a proportion of bean sprouts rating 12 points or more in the results of sensory evaluation among 10 bean sprouts.

TABLE 6

| Sensory | | 100° | 120° | 180° | 220° | 250° | |
|---|---|---|---|---|---|---|---|
| evaluation | Fresh | C. | C. | C. | C. | C. | Blanching |
| 60 seconds | — | 6 | 11.3 | 13.1 | 11.6 | 11.6 | 6.8 |
| 100 seconds | | 9 | 12.6 | 13.5 | 11.4 | 9 | 7.9 |

TABLE 7

| Sense ≥ | | 100° | 120° | 180° | 220° | 250° | |
|---|---|---|---|---|---|---|---|
| 12 rate | Fresh | C. | C. | C. | C. | C. | Blancing |
| 60 seconds | — | 0% | 75% | 100% | 62% | 75% | 0% |
| 100 seconds | | 50% | 87% | 100% | 75% | 50% | 0% |

It has been suggested from the results of Table 1 to Table 7 that while the changes do not necessarily occur in response to the heating time and temperature due to the course of complicated states including a supercooled state and its released state, changes occur in response to time and temperature as a whole, and good texture is provided even with a short time of about 60 seconds at 120° C. 180° C. 220° C., and 250° C. In addition, in the case of 250° C., texture was lost on the contrary when heating was conducted for 100 seconds or longer, rating clearly decreases, and it has been suggested that moderate heating which is conducted in pretreatment of supercooling is effective for providing a supercooled frozen state for obtaining a good frozen state. However, when heating is excessively conducted, it has been clear that texture is lost while supercooling freezing occurs. It is thought to be because excessive heating damages tissues.

When the results of supercooling temperatures and sensory examination were compared, a certain effect of improving texture was observed (for example, 120° C., 60 seconds) at the time when the supercooling temperature decreased to less than −9° C. When the supercooling temperature further decreased, a certain effect of improving physical properties has been confirmed (100° C., 100 seconds; 250° C. 60 seconds; etc.). Consequently, it has been suggested that there is a certain correlation between the supercooling temperatures and the results of sensory evaluation. It has been suggested that it is effective to cause supercooling to occur at a lower temperature for retaining texture even after a supercooled frozen state is generated.

In the Comparative Example in which fresh bean sprouts were allowed to stand still in a freezer at an atmospheric temperature of −15° C. in advance, freezing started promptly at the time when the article temperature decreased to less than 0° C., and so-called supercooled state was not generated. When the frozen bean sprouts manufactured in the Comparative Example was subjected to sensory examination, 3 points for chewiness, 3 points for crispness, 3 points for crunchy feeling, and a total of 9 points were obtained, and the structure of bean sprout tissues was broken as a whole, resulting in limp texture without tautness, with texture such as chewiness, crispness, and crunchy feeling lost.

### Example 2

Heat Treatment by Stir-Frying Heating

In this Example, a case where heat treatment by stir-frying heating was conducted was studied. Specifically, bean sprouts subjected to heat treatment by stir-frying (two and a half minutes), bean sprouts subjected to superheated steam heat treatment (120° C., 100 seconds or 300 seconds), and fresh bean sprouts were compared by investigating properties in the same manner as in Example 1.

Results are shown in Table 8. As shown in Table 8, supercooling freezing may be caused also by heat treatment by a sir-frying step.

TABLE 8

| | | | | | Supercooling | | | | |
|---|---|---|---|---|---|---|---|---|---|
| | | | | | release | Supercooling | | | |
| | | | | Release | temperature | release | Sense ≥ | | Sense |
| Heating | | Time | Supercooling | occurrence | (° C., | temperature ≤ | 12 | Sense | (standard |
| method | Temperature | (second) | rate | rate | average) | −9° C. | rate | (average) | deviation) |
| Stir- | | 150 | 100% | 17% | −6.05 | 25% | 25% | 10.90 | 0.75 |
| frying | | | | | | | | | |

### Example 3

Heat Treatment by Steaming Heating

In this Example, a case where heat treatment by steaming heating was conducted was studied.

Specifically, 50 g of bean sprouts were steamed and heated for 60 seconds, 120 seconds, or 180 seconds in a steamer box (manufactured by ARAHATA FOOD MACHINE CO., LTD.) and subsequently allowed to stand still in a low temperature thermostatic device set at −15° C. in advance for 15 minutes to record changes in temperature of respective bean sprouts. Respective properties were examined in the same manner as in Example 1.

Results are shown in Table 9.

TABLE 9

| | | | | | Supercooling | | | | |
|---|---|---|---|---|---|---|---|---|---|
| | | | | | release | Supercooling | | | |
| | | | | Release | temperature | release | Sense ≥ | | Sense |
| Heating | | Time | Supercooling | occurrence | (° C., | temperature ≤ | 12 | Sense | (standard |
| method | Temperature | (second) | rate | rate | average) | −9° C. | rate | (average) | deviation) |
| Steaming | 100° C. | 60 | 75% | 100% | −4.6 | 0% | 25% | 9.38 | 1.80 |
| | 100° C. | 120 | 75% | 100% | −5.93 | 0% | 0% | 8.50 | 0.87 |
| | 100° C. | 180 | 25% | 100% | −2.6 | 0% | 0% | 5.38 | 3.68 |

As shown in Table 9, when the steaming step was conducted as pretreatment, supercooling occurred at a relatively high supercooling rate of 75% in the samples subjected to the steaming step (100° C.) for 60 seconds and 120 seconds. In the sample subjected to steaming heating treatment at 100° C. for 180 seconds, only 25% thereof shifted to a supercooled state, and the rest of the samples shifted to a frozen state without undergoing a supercooled state, and could not be highly rated also in sensory evaluation.

When the case of heating with superheated steam and the case of steaming heating were compared, appropriate supercooling occurred, and supercooling was released to shift to a frozen state in those subjected to the steaming step for an appropriate time (60 seconds to 120 seconds): however, results of sensory examination were not preferable. It is presumed that these results are obtained because the effect of pretreatment similar to that obtained by superheated steam treatment cannot be obtained when the steaming step is conducted as pretreatment, therefore, the supercooling release temperature is relatively high, causing ice crystals to become bigger, and rating in the sensory examination consequently decreases.

### Example 4

Effect of Surface Treatment Before Cooling

In this Example, an effect of process of removing moisture from surfaces of vegetables before cooling was studied.

Since the effect differed between steaming heating and superheated steam treatment in Example 3 (for example, in the cases where the temperature was 100° C.), in this Example, the correlation between the state of moisture on tissue surfaces and stability of supercooling was studied. In the case of the steaming step, since the treatment is conducted in a state of being filled with saturated water vapor, excess moisture is present on tissue surfaces. Meanwhile, in the case of superheated steam treatment where tissues are heated by hot air, surfaces of tissues are in a dry state. Whether the difference therebetween affect the effect of the present invention or not was studied.

Specifically, since excess moisture attached to surfaces of bean sprouts in the case where 50 g of bean sprouts were heated at 100° C. for 100 seconds by a superheated steam oven, moisture on the bean sprout surfaces was removed by pressing a paper towel from above the bean sprouts. In addition, since surfaces were in a dry state in the case of bean sprouts subjected to heat treatment at 180° C. for 60 seconds by superheated steam, about 5 ml of water was allowed to attach to the entire surfaces of the bean sprouts using a sprayer. The water treatment was conducted to investigate an effect of the state of moisture on the bean sprout surfaces after heating. The cooling method, temperature measurement, and sensory evaluation were carried out in the same manner as in Example 1.

Results are shown in Table 10.

TABLE 10

| | | | | | | Supercooling | | | | |
|---|---|---|---|---|---|---|---|---|---|---|
| | | | | | | release | | | | |
| | | | | | Release | temperature | Supercooling | Sense ≥ | | Sense |
| Heating | | Time | Water | Supercooling | occurrence | (° C., | temperature ≤ | 12 | Sense | (standard |
| method | Temperature | (second) | treatment | rate | rate | average) | −9° C. | rate | (average) | deviation) |
| Superheated | 100° C. | 60 | Absence | 87.5% | 100.0% | −3.9 | 12.5% | 12.5% | 9.6 | 1.1 |
| steam | 100° C. | 60 | Wiping | 60.0% | 100.0% | −7.9 | 40.0% | 33.3% | 10.1 | 2.5 |
| | 180° C. | 60 | Absence | 90.9% | 100.0% | −8.9 | 50.0% | 33.3% | 10.4 | 1.7 |
| | 180° C. | 60 | Attaching | 80.0% | 100.0% | −6.6 | 20.0% | 25.0% | 9.0 | 2.3 |
| | | | water | | | | | | | |

As is clear from Table 10, with respect to superheated steam, all samples showed high values in terms of supercooling rates and release occurrence rates, suggesting that supercooling freezing stably occurred. On the other hand, when the supercooling temperatures were compared, in the case of 100° C., a lower temperature was obtained when moisture was wiped off, and in the case of 180° C., a lower temperature was obtained when moisture was not allowed to attach. This result was consistent with the results of sensory examination as with Example 3. That is, it has become clear that as the supercooling temperature decreases, the retained texture is tougher.

From the above results, it has been shown that decrease of supercooling temperature is promoted by removing moisture from the surfaces of vegetables to improve results of sensory evaluation. Also, in the case of steaming heating, it is thought that an effect similar to the case of superheated steam treatment can be obtained by removing moisture from the surfaces of vegetables or fruit.

### Example 5

Examination of Cooling Conditions for Heat-Treated Vegetables

In this Example, cooling conditions of heat-treated vegetables were evaluated. Specifically, cooling treatment was conducted on heat-treated vegetables under various cooling conditions to study supercooling situations and conduct sensory evaluation. First, heat treatment was conducted on 50 g of bean sprouts with superheated steam at 180° C. for 60 seconds using a superheated steam oven. Thereafter, each heat-treated bean sprout was allowed to stand still in a low temperature incubator set at −5° C., −10° C., −15° C., −20° C., −25° C., or −30° C. in advance for 15 minutes. Properties were examined in the same manner as in Example 1.

Results are shown in Table 11.

TABLE 11

| | | Supercooling | | | | |
|---|---|---|---|---|---|---|
| | | release | | | | |
| | Release | temperature | Supercooling | Sense ≥ | | Sense |
| Supercooling | occurrence | (° C., | temperature ≤ | 12 | Sense | (standard |

| Temperature | Time | rate | rate | average) | −9° C. | rate | (average) | deviation) |
|---|---|---|---|---|---|---|---|---|
| −5° C. | 15 | 100% | 37.5% | −5.2 | 0.0 | 25.0% | 10.8 | 0.7 |
| | minutes | | | | | | | |
| −10° C. | 15 | 100% | 0% | −9.6 | 88.9 | 83.3% | 11.0 | 1.3 |
| | minutes | | | | | | | |
| −15° C. | 15 | 100% | 100% | −11.9 | 87.5 | 75.0% | 11.1 | 2.1 |
| | minutes | | | | | | | |
| −20° C. | 15 | 88.9% | 100% | −5.6 | 11.1 | 0.0% | 10.5 | 0.0 |
| | minutes | | | | | | | |
| −25° C. | 15 | 80% | 100% | −5.1 | 10.0 | 0.0% | 9.9 | 0.8 |
| | minutes | | | | | | | |
| −30° C. | 15 | 77.8% | 100% | −1.6 | 0.0 | 0.0% | 8.7 | 3.2 |
| | minutes | | | | | | | |

As shown in Table 11, it has been shown that in the bean sprouts subjected to heat treatment, supercooling occurs at a high rate when the bean sprouts are allowed to stand still under a cooling condition of −5° C. to −30° C. In addition, when comparing supercooling release temperatures, as the cooling temperature is decreased, the supercooling release temperature also gradually decreases and decreases to −11.9° C. at a cooling temperature of −15° C. When the cooling temperature is further decreased, the supercooling release temperature turns upward, and variation between samples is observed more often. Especially, it is presumed that the supercooling release temperature became such a high temperature in the case where the cooling temperature was −30° C. because the cooling condition was excess for the sample, and the sample was directly frozen before entering a supercooled state. In addition, it has been shown that the rate of supercooling release temperature reaching −9° C. is high in the conditions where the samples were allowed to stand still at −10° C. and −15° C. compared with other conditions. Accordingly, it has been suggested that results of sensory evaluation with the conditions under which the samples were allowed to stand still at −10° C. and −15° C. are also preferable.

### Example 6

Texture evaluation on frozen vegetables by instrumental analysis

In this Example, texture of frozen vegetables was evaluated by instrumental analysis. Specifically, texture of supercooled vegetables was evaluated, with the cooling conditions of −10° C. and −15° C. under which the results of sensory evaluation were preferable in Example 5 as reference. Measurement conditions are as follows.

(1) Device

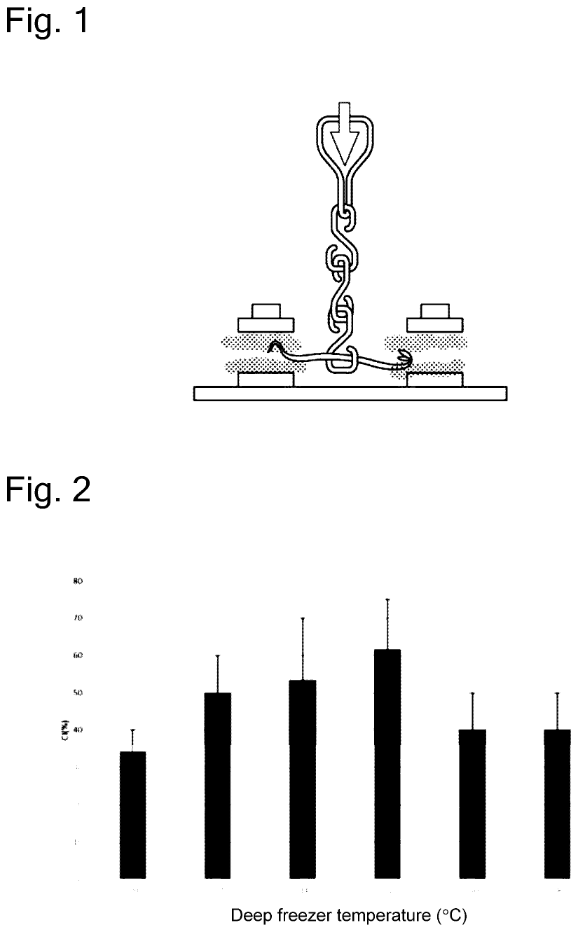

A texture analyzer from Stable Micro Systems was used. Attachments shown in FIG. 1 were used. A bean sprout can be cut with a hook by hooking the central part thereof, with a thin spongy substance placed between wood pieces, and the bean sprout fixed so as not to be crushed.

(2) Method

Fresh bean sprouts (mung bean sprouts manufactured by Narita Foods Co., Ltd.) bought on the day of experiment were used. Blanching was conducted by heating 50 g of fresh bean sprouts arranged avoiding overlapping for 120 seconds using a steamer having a diameter of 30 cm. Thereafter, moisture on the surfaces of bean sprouts was sucked up by Kimtowel, a deep freezer (manufactured by TWINBIRD CORPORATION) was set to −20° C., −17° C., −14° C., −12° C., −10° C., or −8° C. (cooling temperature), and fifteen bean sprouts were arranged on a baking paper and allowed to remain still for 30 minutes. Thereafter, the bean sprouts were preserved in a storage at −20° C. overnight. This procedure was repeated three times for each temperature. The bean sprouts were thawed at normal temperature on the next day, and texture thereof was measured using a texture analyzer.

Uncooked bean sprouts have uneven surfaces and split cut when uncooked bean sprouts are cut off (irregularities). These irregularities relate to crunchy feeling at the time of eating. Texture of bean sprouts which had been supercooled at each cooling temperature and frozen thereafter was measured (n=30), and a proportion of bean sprouts having texture similar to that of uncooked bean sprouts (fresh) among all bean sprouts subjected to texture measurement was examined.

Results are shown in FIG. 2. CI (Crispiness Index (%)) in FIG. 2 is a proportion of bean sprouts having texture similar to that of uncooked bean sprouts (fresh) among all bean sprouts subjected to texture measurement. As shown in FIG. 2, 40% or more of bean sprouts having been supercooled under cooling conditions from −8° C. to −17° C. had texture similar to that of uncooked bean sprouts. In addition, it has been shown that bean sprouts supercooled at −12° C. has texture most similar to the texture of uncooked bean sprouts. In addition, the above evaluation on texture had a tendency similar to the results of sensory evaluation in Example 1.

### Example 7

Tissue Observation of Frozen Bean Sprouts

In this Example, tissues of frozen bean sprouts were observed.

(1) Description of Device

Samples were dried using a vacuum freeze dryer RLE-52 manufactured by Kyowa Vacuum Engineering Co., Ltd. Micro-CT scanner SkyScan 1172 manufactured by TOYO Corporation was used for observing samples.

(2) Method

Fresh bean sprouts (mung bean sprouts manufactured by Narita Foods Co., Ltd.) bought on the day of experiment was used as a sample as in the texture measurement. Blanching was conducted by heating 50 g of fresh bean sprouts arranged so as to avoid overlapping for 120 seconds using a steamer having a diameter of 30 cm. Thereafter, moisture on the surfaces of bean sprouts was sucked up by Kimtowel (registered trademark), a deep freezer (manufactured by TWINBIRD CORPORATION) was set to −12° C., and bean sprouts were arranged on a baking paper and allowed to remain still for 30 minutes. Thereafter, the bean sprouts were preserved in a storage at −20° C.

As a Comparative Example, a sample was subjected to blanching in the same manner and subsequently cryopreserved in a storage at −60° C.

Thereafter, the samples were dried by a vacuum freeze dryer at −40° C. for 36 hours, at −30° C. for 2 hours, at −20° C. for 2 hours, at −10° C. for 2 hours, at 0° C. for 2 hours, at 10° C. for 2 hours, and at 20° C. for 2 hours, respectively. X-ray CT images of the obtained dried samples were taken and observed.

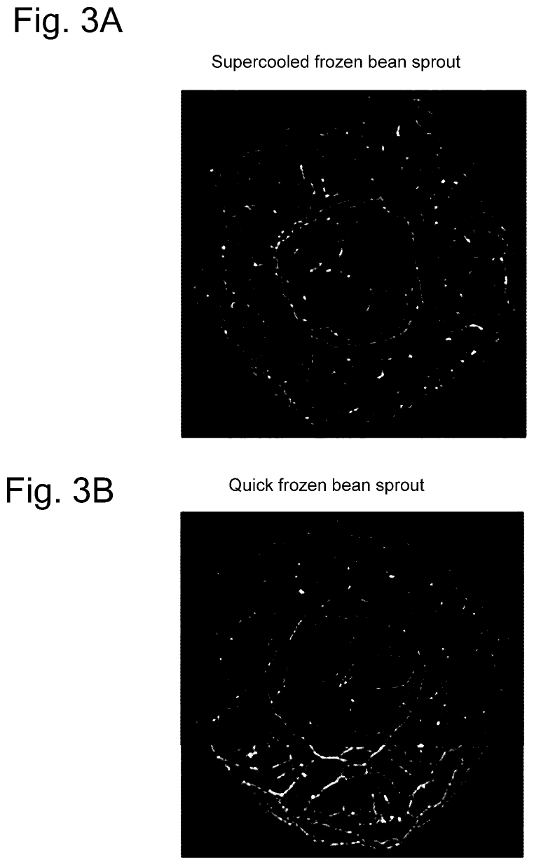

Results are shown in FIG. 3A and FIG. 3B. A cross-sectional surface with coarse tissues and many pores was observed in bean sprouts subjected to quick freezing. On the other hand, bean sprouts subjected to supercooling retained dense tissues. From this result, it has been suggested that while the tissues of bean sprouts subjected to quick freezing were broken to make pores coarse due to growth of ice crystals, the cell tissues of bean sprouts subjected to supercooling were not broken and were and retained, because the size of ice crystals remained small.

### Example 8

Examination of Treatment Conditions for Various Vegetables and Fruit

In this Example, treatment conditions were studied using various kinds of vegetables or fruit.

Material: onions (cut into wedges), bell peppers (cut into wedges), carrots (5×5 dice, cut into narrow rectangles), radishes (breed: Aokubi Daikon), (5×5×40 mm, 10×10×40 mm), spinach (4 cm length), lettuces (3 cm length), and apples (cut into ⅛ and further sliced into about 5 mm)

As heat treatment, treatment with superheated steam at 100° C., 180° C., 220° C., or 250° C. was conducted for 60 seconds, 100 seconds, or 150 seconds for each temperature using a superheated steam oven, or blanching to immerse material in a boiled water bath for a predetermined time was conducted.

50 g of each of vegetables or fruits were allowed to stand still for 15 minutes or 30 minutes in a freezer set to −15° C. in advance, and a temperature change of each of vegetables or fruit was recorded. Respective properties were examined in the same manner as in Example 1. Results are shown in Table 12 to Table 18.

Onions

TABLE 12
Onions

| | | | | | Supercooling | Supercooling | | | | |
|---|---|---|---|---|---|---|---|---|---|---|
| | | | | | release | release | | | | |
| | | | | Release | temperature | temperature | Supercooling | Sense ≥ | | Sense |
| Heating | | Time | Supercooling | occurrence | (° C., | (standard | temperature ≤ | 12 | Sense | (standard |
| method | Temperature | (second) | rate | rate | average) | deviation) | −9° C. | rate | (average) | deviation) |
| Superheated | 100° C. | 60 | 62.5% | 100% | −4.74 | 1.30 | 0% | 0% | 6.0 | 0.0 |
| steam | 100° C. | 100 | 100% | 100% | −10.06 | 2.21 | 60% | 50% | 9.0 | 3.2 |
| | 120° C. | 60 | 87.5% | 100% | −9.86 | 2.44 | 80% | 75% | 11.3 | 3.3 |
| | 120° C. | 100 | 100% | 100% | −10.89 | 1.35 | 87.5% | 87.5% | 12.6 | 2.7 |
| | 180° C. | 60 | 100% | 100% | −11.24 | 0.54 | 100% | 100% | 13.1 | 0.7 |
| | 180° C. | 100 | 100% | 100% | −11.61 | 0.62 | 100% | 100% | 13.5 | 0.0 |
| | 220° C. | 60 | 100% | 100% | −11.85 | 0.70 | 100% | 62.5% | 11.6 | 1.9 |
| | 220° C. | 100 | 100% | 100% | −11.98 | 0.68 | 100% | 75% | 11.4 | 2.7 |
| | 250° C. | 60 | 100% | 100% | −12.14 | 0.34 | 100% | 75% | 11.6 | 1.8 |
| | 250° C. | 100 | 100% | 100% | −11.96 | 0.46 | 100% | 50% | 9.0 | 3.2 |
| Blanching | 100° C. | 60 | 62.5% | 100% | −8.79 | 2.16 | 50% | 37.5% | 8.6 | 3.0 |
| | 100° C. | 120 | 100% | 100% | −5.81 | 2.09 | 0% | 0% | 6.4 | 1.1 |

From the results in Table 12, it has been shown that supercooling occurs when fresh onions are subjected to pretreatment of blanching or superheated steam. Since supercooling is released after the supercooling temperature reaches −9° C. to −13° C. in the case of superheated steam, results thereof were more preferable than quick freezing. In the case of blanching, supercooling is released at a supercooling temperature of −5° C. to −9° C., which is higher than that in treatment with superheated steam. Sensory evaluation was also inferior to the case of quick freezing (9 points).

Bell Peppers

TABLE 13
Bell peppers

| | | | | | | Supercooling | Supercooling | | | | |
|---|---|---|---|---|---|---|---|---|---|---|---|
| | | | | | | release | release | | | | |
| | Cooling | | Heating | | Release | temperature | temperature | Supercooling | Sense ≥ | | Sense |
| Heating | time | Heating | time | Supercooling | occurrence | (° C., | (standard | temperature ≤ | 12 | Sense | (standard |
| method | (minute) | temperature | (second) | rate | rate | average) | deviation) | −9° C. | rate | (average) | deviation) |
| Superheated | 30 | 180 | 100 | 100% | 100% | −10.73 | 2.26 | 100% | 75% | 12.3 | 2.2 |
| steam | | | | | | | | | | | |

Carrots

TABLE 14
Carrots

| | | | | | | | Super- | Super- | | | | |
|---|---|---|---|---|---|---|---|---|---|---|---|---|
| | | | | | | | cooling | cooling | | | | |
| | | | | | | | release | release | Super- | | | |
| | | Cooling | | Heating | Super- | Release | temperature | temperature | cooling | Sense ≥ | | Sense |
| Heating | | time | Temper- | time | cooling | occurrence | (° C., | (standard | temperature ≤ | 12 | Sense | (standard |
| method | Shape | (minute) | ature | (second) | rate | rate | average) | deviation) | −9° C. | rate | (average) | deviation) |
| Super- | Dice | 30 | 180 | 60 | 100% | 100% | −7.33 | 1.63 | 25% | 0% | 9.9 | 0.9 |
| heated | Narrow | 30 | 180 | 100 | 100% | 75% | −9.30 | 3.16 | 50% | 0% | 10.4 | 0.9 |
| steam | rectangle | | | | | | | | | | | |
| | Narrow | 30 | 180 | 150 | 100% | 50% | −11.15 | 0.49 | 100% | 25% | 11.1 | 0.8 |
| | rectangle | | | | | | | | | | | |

Radishes

TABLE 15
Radishes

| | | | | | | | Super- | Super- | | | | |
|---|---|---|---|---|---|---|---|---|---|---|---|---|
| | | | | | | | cooling | cooling | | | | |
| | | | | | | | release | release | Super- | | | |
| | | Cooling | | Heating | Super- | Release | temperature | temperature | cooling | Sense ≥ | | Sense |
| Heating | | time | Temper- | time | cooling | occurrence | (° C., | (standard | temperature ≤ | 12 | Sense | (standard |
| method | Shape | (minute) | ature | (second) | rate | rate | average) | deviation) | −9° C. | rate | (average) | deviation) |
| Super- | 5 × 5 × | 30 | 200 | 60 | 100% | 100% | −11.46 | 1.45 | 100% | 100% | 12.0 | 0.0 |
| heated | 40 mm | | | | | | | | | | | |
| steam | 10 × 10 × | 30 | 200 | 60 | 100% | 100% | −10.70 | 1.55 | 75% | 100% | 13.0 | 0.0 |
| | 40 mm | | | | | | | | | | | |

Spinach

TABLE 16
Spinach

| | | | | | | Supercooling | Supercooling | | | | |
|---|---|---|---|---|---|---|---|---|---|---|---|
| | | | | | | release | release | | | | |
| | Cooling | | Heating | | Release | temperature | temperature | Supercooling | Sense ≥ | | Sense |
| Heating | time | | time | Supercooling | occurrence | (° C., | (standard | temperature ≤ | 12 | Sense | (standard |
| method | (minute) | Temperture | (second) | rate | rate | average) | deviation) | −9° C. | rate | (average) | deviation) |
| Blanching | 60 | 100 | 60 | 67% | 100% | −10.90 | 0.74 | 100% | 0% | 9.8 | 1.2 |

Lettuces

TABLE 17
Lettuces

| | | | | | | Supercooling | Supercooling | | | | |
|---|---|---|---|---|---|---|---|---|---|---|---|
| | | | | | | release | release | | | | |
| | Cooling | | Heating | | Release | temperature | temperature | Supercooling | Sense ≥ | | Sense |
| Heating | time | | time | Supercooling | occurrence | (° C., | (standard | temperature ≤ | 12 | Sense | (standard |
| method | (minute) | Temperture | (second) | rate | rate | average) | deviation) | −9° C. | rate | (average) | deviation) |
| Blanching | 30 | 100 | 30 | 100% | 100% | −11.12 | 2.64 | 75% | 100% | 12.9 | 0.3 |
| Superheated | 30 | 200 | 60 | 100% | 100% | −13.90 | 0.99 | 100% | 100% | 13.4 | 0.3 |
| steam | 30 | 200 | 100 | 75% | 100% | −12.77 | 1.9 | 100% | 75% | 12.5 | 1.2 |

According to the results in Tables 13 to 17, with respect to bell peppers, radishes, and lettuces, the supercooling temperatures also reached to −9° C., and the supercooling release rates were also good. Results of sensory evaluation were also good. In addition, with respect to spinach, while the supercooling temperature reached to −9° C. under the tested heat treatment conditions (blanching at 0° C. for 60 seconds), sensory evaluation was slightly lower. With respect to carrots, when carrots having an arrow rectangle shape were subjected to certain heat treatment with superheated steam (180° C. for 100 seconds or 150 seconds), the supercooling temperature reached to −9° C., but sensory evaluation was slightly lower.

Apples

TABLE 18
Apples

| | | | | | | Supercooling | Supercooling | | | |
|---|---|---|---|---|---|---|---|---|---|---|
| | | | | | | release | release | | | |
| | | | | | Supercooling | temperature | temperature | Supercooling | | Sense |
| Heating | | Time | | Supercooling | release | (° C., | (standard | temperature ≤ | Sense | (standard |
| method | Temperature | (second) | Cooling | rate | rate | average) | deviation) | −9° C. | (average) | deviation) |
| Fresh | | | −15° C. | 0% | 0% | | | 0% | 6.0 | 0.0 |
| Superheated | 180° C. | 30 seconds | −15° C. | 100% | 100% | −3.79 | 0.98 | 0% | 6.0 | 0.6 |
| steam | 180° C. | 60 seconds | −15° C. | 100% | 100% | −3.70 | 0.52 | 0% | 7.5 | 0.0 |
| | 180° C. | 100 seconds | −15° C. | 75% | 100% | −3.63 | 0.45 | 0% | 10.0 | 0.9 |
| | 180° C. | 60 seconds | −22° C. | 50% | 100% | −4.35 | 0.21 | 0% | | |
| | 180° C. | 100 seconds | −22° C. | 50% | 100% | −4.17 | 0.25 | 0% | | |
| Fresh | | | Quick | 0% | 0% | | | 0% | 7.5 | 0.0 |
| Superheated | 180° C. | 30 seconds | Quick | 0% | 0% | | | 0% | 6.0 | 0.0 |
| steam | 180° C. | 60 seconds | Quick | 0% | 0% | | | 0% | 6.8 | 0.0 |
| | 180° C. | 100 seconds | Quick | 0% | 0% | | | 0% | 9.0 | 0.0 |

As shown in Table 18, supercooling does not occur in fresh apples. On the other hand, it has been shown that supercooling occurs when pretreatment with superheated steam is conducted. Supercooling temperature is −3° C. to −4° C., and sensory evaluation slightly improved in apples subjected to supercooling compared with apples subjected to quick freezing.

Hereinbefore, frozen vegetables with good texture could be prepared by supercooling freezing method using various kinds of vegetables and fruit.

### Example 9

Addition to Ramen Soup

Using the method in Example 1, 50 g of fresh bean sprouts were subjected to superheated steam treatment at 180° C. for 60 seconds and subsequently allowed to stand still at −15° C. for 15 minutes to prepare supercooled frozen bean sprouts. As a Comparative Example, 50 g of fresh bean sprouts were subjected to superheated steam treatment at 180° C. for 60 seconds similarly to the example and subsequently subjected to quick freezing at −40° C. to prepare quick frozen bean sprouts.

To 30 cc of a ramen soup stock solution (Tetsujin Tonkotsu-shoyu, Fuji Foods Corporation), 220 cc of hot water was added, and Chinese noodles (NEW ramen noodles, 200 g, TableMark Co., Ltd.) heated up with a microwave oven for three minutes were put in the ramen soup, followed by being topped with 70 g of frozen bean sprouts to cook a vegetable ramen. The frozen bean sprouts in the vegetable ramen were provided for sensory examination with trained 13 panelists.

TABLE 19

| | Crispness | | Chewiness | | Crunchy feeling | |
|---|---|---|---|---|---|---|
| | Quick | Supercooling | Quick | Supercooling | Quick | Supercooling |
| Average | 2.8 | 3.5 | 2.5 | 4.0 | 2.5 | 4.0 |
| Standard | 0.7 | 0.7 | 0.7 | 0.8 | 0.8 | 1.0 |
| deviation | | | | | | |

Results thereof are shown in Table 19. Evaluation was made based on the score of quick frozen bean sprouts solely evaluated in sensory examination in each item as three points (on a five-point scale). Quick frozen bean sprouts with which the ramen was topped scored lower points than those obtained in the case where quickly frozen bean sprouts were solely sensory evaluated (three points for each item). It is presumed to be because the bean sprouts were further steamed with steam and became soggy by topping the ramen soup heated up with a microwave oven therewith. On the other hand, even in bean sprouts subjected to supercooling freezing, while the scores thereof were inferior to that obtained in the case where vegetables are solely sensory evaluated in the same manner (Table 6, 180° C., 60 seconds), high rating was once obtained, and high rating was obtained for all items of chewiness, crispness, and crunchy feeling compared with bean sprouts subjected to quick freezing. From this result, it has been shown that by virtue of using frozen vegetables (bean sprouts) subjected to supercooling freezing, texture is retained better than frozen vegetables obtained by a conventional quick freezing method, and a sensory excellent vegetable ramen can be provided.

### Example 10

Elastic Modulus of Bean Sprouts

In this Example, an elastic modulus of bean sprouts after supercooling freezing was measured.

Using a steamer having a diameter of 30 cm, 50 g of fresh bean sprouts were subjected to heat treatment at 100° C. for 120 seconds. Ina deep freezer (manufactured by TWINBIRD CORPORATION) set to −12° C. in advance or a storage (manufactured by Thermo Magic Co., Ltd.) set to −20° C., −30° C., or −80° C. 50 g of the heat-treated bean sprouts were allowed to stand still overnight. The frozen bean sprouts were allowed to stand still at room temperature for 60 minutes to be thawed and provided for elastic modulus measurement. As a Comparative Example, 50 g of bean sprouts which were subjected to steam superheating treatment at 100° C. for 120 seconds using a steamer having a diameter of 30 cm and which were not frozen were used.

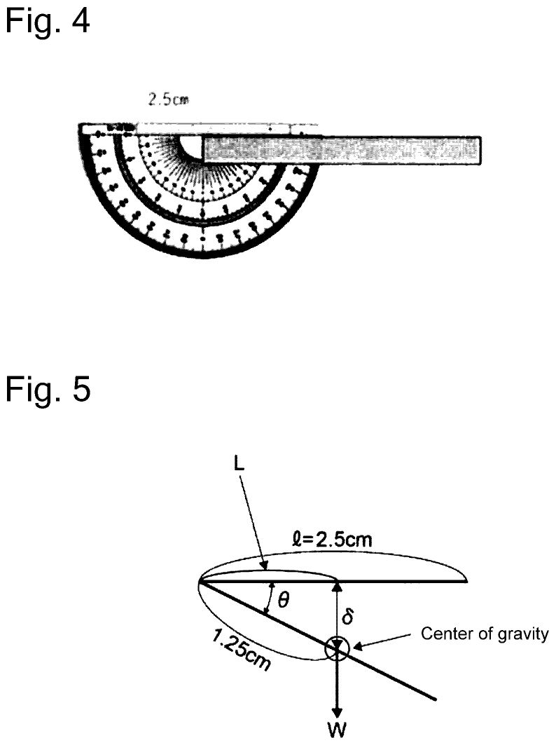

The elastic modulus measurement method was as follows: 10 bean sprouts were randomly selected from 50 g of bean sprouts having been subjected to pretreatment and allowed to stand still on a support. The method for allowing bean sprouts to stand still on a support was as follows: the beans sprouts were allowed to protrude out of the support by 2.5 cm, and an angle at which the part protruded from the support was bent by a load was measured using a protractor (FIG. 4).

Young's modulus was calculated from the angle of bending (θ) determined according to the following calculation method and the diameter (D) of one bean sprout, assuming that the whole load was applied to the center of gravity, with the center of gravity lying at 1.25 cm of the protruded bean sprout (Chemical Formula 1, FIG. 5).

$$[ Chemical Formula 1 ]$$

$$\begin{matrix}δ = 1.25 sin θ \\ W = p \text{?} ( \frac{D}{2} ) {}^{2} ϑ ⇋ 1 \times \text{?} \times \frac{2.5}{4} \times {D}^{2} = 1.963 {D}^{2} \times 980 \\ L = 1.25 cos θ \\ {I}_{2} = \frac{{nr}^{4}}{4} = \frac{π}{4} ( \frac{D}{2} ) {}^{4} = 0.0491 \times {D}^{4} \\ \\ E = \frac{W}{δ I z} \times \frac{{L}^{3}}{3} = \frac{1}{3} \cdot \frac{W}{δ I z} \cdot {L}^{3} = 2.04 \times {10}^{4} \times \frac{{( cos θ )}^{3}}{{D}^{2} \cdot sin θ}\end{matrix}$$

$$\text{?} \text{indicates text missing or illegible when filed}$$

E: Young's modulus (dyn/cm²)
D: Diameter of one bean sprout (cm)
θ: Angle of bending due to load (°, so-called deflection)

### W: Load

L: Length to which load of needle is applied
The length of the needle was calculated assuming that the whole load is applied to 1.25 cm of the protruded bean sprout.
   I_{z}: Sectional secondary moment

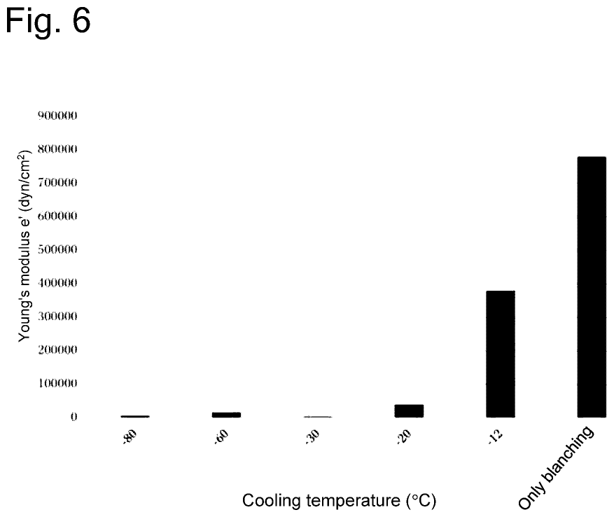

Results are shown in Table 20 and FIG. 6.

TABLE 20

| Cooling | | | |
|---|---|---|---|
| temper- | Angle | Diameter | |
| ature (° C.) | (°) | (cm) | e′ (dyn/cm²) |
| Only blanching | 11 | 0.36 | 0.7803 × 10⁶ |
| −12 | 26.5 | 0.294 | 0.3791 × 10⁶ |
| −20 | 62 | 0.249 | 0.3855 × 10⁵ |
| −30 | 77 | 0.25 | 0.3828 × 10⁴ |
| −60 | 72.2 | 0.247 | 0.9976 × 10⁴ |
| −80 | 75.6 | 0.232 | 0.6062 × 10⁴ |

As described in Table 20 and FIG. 6, the bean sprouts frozen at −12° C. showed an elastic modulus at least about 10 times higher than that in the case where bean sprouts were frozen under a lower temperature of −20° C. or lower. A higher elastic modulus relates to firmer texture.

1. A method for freezing vegetables or fruit, comprising
(i) subjecting vegetables or fruit to heat treatment;
(ii) cooling the vegetables or fruit of step (i) by allowing the vegetables or fruit stand still under a condition of −1° C. to −18° C., thereby allowing the vegetables or fruit to become in a supercooled state, and subsequently releasing the supercooled state; and
(iii) freezing the vegetables or fruit of step (ii),
wherein
the heat treatment of step (i) is heat treatment to the extent at which cell tissues of the vegetables or fruit are not destroyed even after freezing treatment of step (iii).

2. The freezing method according to claim 1, wherein
the supercooled state is released at −9° C. or lower in step (ii).

3. The freezing method according to claim 1, wherein
the vegetables or fruit is cooled by allowing the vegetables or fruit stand still under a condition of −9° C. to −18° C. in step (ii).

4. The freezing method according to claim 1, wherein
the vegetables or fruit is cooled by allowing the vegetables or fruit stand still under a condition of −9° C. to −15° C. in step (ii).

5. The freezing method according to claim 1, wherein
moisture on surfaces of the vegetables or fruit is removed after the heat treatment of step (i).

6. The method according to claim 1, wherein
the heat treatment of step (i) is conducted under a condition of 60° C. to 250° C.

7. The method according to claim 1, wherein
the heat treatment of step (i) is conducted under a condition of 100° C. to 250° C.

8. The method according to claim 1, wherein
the heat treatment of step (i) is conducted for 10 to 600 seconds.

9. The method according to claim 1, wherein
the heat treatment of step (i) is conducted for 30 to 600 seconds.

10. The method according to claim 1, wherein
the heat treatment of step (i) is conducted by superheated steam heating, steaming heating, or stir-frying heating.

11. The method according to claim 1, wherein
the release of the supercooled state of step (ii) naturally occurs without any external stimulus.

12. The method according to claim 1, wherein
the vegetables are selected from the group consisting of bean sprouts, onions, bell peppers, paprikas, carrots, radishes, spinach, cabbages, lettuces, broccolis, cauliflowers, asparagus, potatoes, green onions, and ginger.

13. The method according to claim 1, wherein
the fruit is selected from the group consisting of apples, watermelons, pears, grapes, peaches, mangoes, citrus fruits, bananas, pineapples, and berries.

14. Vegetables or fruit, frozen by the method according to claim 1.
